(19) United States
(12) Patent Application Publication
(10) Pub. No.: US 2024/0340763 A1
(43) Pub. Date: Oct. 10, 2024

(54) METHOD AND DEVICE FOR NETWORK SLICE REPLACEMENT BASED ON TERMINAL IN WIRELESS COMMUNICATION SYSTEM

(71) Applicant: Samsung Electronics Co., Ltd., Gyeonggi-do (KR)

(72) Inventors: Dongeun SUH, Gyeonggi-do (KR); Jungshin PARK, Gyeonggi-do (KR); Jicheol LEE, Gyeonggi-do (KR); Dongyeon KIM, Gyeonggi-do (KR)

(21) Appl. No.: 18/627,946

(22) Filed: Apr. 5, 2024

(30) Foreign Application Priority Data
Apr. 7, 2023 (KR) 10-2023-0046341

(51) Int. Cl. H04W 40/22; H04W 48/18; H04W 76/10

(52) U.S. Cl. CPC H04W 40/22; H04W 48/18; H04W 76/10

(57) ABSTRACT

The disclosure relates to a 5G or 6G communication system for supporting a higher data transmission rate. A method performed by a user equipment (UE) in a wireless communication system includes identifying, while the UE is in an evolved packet system (EPS), a network slice based on a UE route selection policy (URSP) rule, moving from the EPS to a 5th generation system (5GS), and transmitting, to a base station, information on the network slice.

### CROSS-REFERENCE TO RELATED APPLICATION(S)

This application is based on and claims priority under 35 U.S.C. § 119 to Korean Patent Application No. 10-2023-0046341, filed on Apr. 7, 2023, in the Korean Intellectual Property Office, the disclosure of which is incorporated herein by reference in its entirety.

### BACKGROUND

### 1. Field

The disclosure relates generally to a communication field, and more particularly, to a method and a device for network slice replacement based on a mobile device in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

A 5G mobile communication network may include a 5G user equipment (UE), a 5G radio access network (RAN), a 5G nodeB (gNB), an evolved node B (eNB), and a 5G core network. The 5G core network may include network functions (NFs) including an access and mobility management function (AMF) that provides a mobility management function for the UE, a session management function (SMF) that provides a session management function, a user plane function (UPF) that performs a data transfer role, a policy control function (PCF) that provides a policy control function, a unified data management (UDM) that provides a function of managing data, such as subscriber data and policy control data, or a unified data repository (UDR) that stores data of various network functions including the UDM.

In a 5G system, network slicing technology concerns several virtualized and independent logical networks being providable in one physical network. A network operator may configure a virtual end-to-end network called a network slice to provide a service to satisfy a specialized requirement of a service/application. A third party (e.g., an application service provider) providing a particular service may make a contract on one or several network slices with a network operator, and allow traffic for a particular application to be transmitted and/or received between a terminal and a server through the contracted slice(s). A network slice may be distinguished by an identifier named a single-network slice selection assistance information (S-NSSAI), and a network may support an S-NSSAI in a tracking area (TA) unit. TA denotes a set of cells, and all the cells may be associated with the TA. An identifier (e.g., a tracking area identity (TAI)) of a TA may be configured by a mobile country code (MCC), a mobile network code (MNC), and a tracking area code (TAC). For example, TA 1 supporting S-NSSAI 1 may indicate that all cells belonging to TA 1 support S-NSSAI 1, and may indicate that all the cells belonging to TA 1 are enabled to perform resource allocation for S-NSSAI 1. A 5G system may force an S-NSSAI to be not available outside an area supporting the S-NSSAI.

Network slicing denotes a structure enabling several virtualized and independent logical networks in one physical network. A network operator may configure a virtual end-to-end network referred to as a network slice to provide a service to satisfy a specialized requirement of a service/application. A network slice may be distinguished by an identifier referred to as a single-network slice selection assistance information (S-NSSAI). A network may transmit an allowed slice set (e.g., allowed NSSAI(s)) to a terminal in a terminal registration procedure (e.g., UE registration procedure), and the terminal may transmit or receive application data through a protocol data unit (PDU) session generated through one S-NSSAI (e.g., a network slice).

Conventionally, if an alternative network slice selected to substitute for a network slice of an existing PDU session is determined to be a slice having already reached a maximum number of sessions, generation of a PDU session through the alternative network slice for replacing the existing PDU session slice is rejected, and thus the continuity of application traffic is not ensured.

As such, there is a need in the art for a method of network slice replacement for a PDU session, based on a terminal, to cure this compromised application traffic continuity in the conventional art.

### SUMMARY

The disclosure has been made to address at least the above-mentioned problems and/or disadvantages and to provide at least the advantages described below.

Accordingly, an aspect of the disclosure is to provide a device and a method for supporting a network slice replacement function for a session, based on a terminal request in a wireless communication system.

An aspect of the disclosure is to provide a terminal that is allowed to perform a network slice replacement request for a PDU session, and thus, can perform processing when a PDU session required to be changed has occurred.

In accordance with an aspect of the disclosure, a method performed by a user equipment (UE) in a wireless communication system includes identifying, while the UE is in an evolved packet system (EPS), a network slice based on a UE route selection policy (URSP) rule, moving from the EPS to a 5th generation system (5GS), and transmitting, to a base station, information on the network slice.

In accordance with an aspect of the disclosure, a method performed by a base station in a wireless communication system includes receiving, from a UE, information on a network slice in case that the UE moves from a PS to a 5GS, wherein the network slice is based on a URSP rule.

In accordance with an aspect of the disclosure, a UE in a wireless communication system includes a transceiver, and at least one processor coupled with the transceiver and configured to identify, while the UE is in an EPS, a network slice based on a URSP rule, move from the EPS to a 5GS, and transmit, to a base station, information on the network slice.

In accordance with an aspect of the disclosure, a base station in a wireless communication system includes a transceiver, and at least one processor coupled with the transceiver and configured to receive, from a UE, information on a network slice in case that the UE moves from an EPS to a 5GS, wherein the network slice is based on a URSP rule.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a communication network including core network entities in a wireless communication system according to an embodiment;

FIG. 2 illustrates a wireless environment including a core network in a wireless communication system according to an embodiment;

FIG. 3 illustrates a method of storing information related to a packet data network (PDN) connection by a UE in a PDN connection generation procedure according to an embodiment;

FIG. 4 illustrates a method of transmitting a slice replacement request by a UE in a registration procedure according to an embodiment;

FIG. 5 illustrates a method of performing, by a UE, an S-NSSAI replacement request for a PDU session in a PDU session modification procedure according to an embodiment;

FIG. 6 illustrates a structure of a terminal according to an embodiment;

FIG. 7 illustrates a structure of a base station according to an embodiment; and

FIG. 8 illustrates a structure of a network entity according to an embodiment of the disclosure.

### DETAILED DESCRIPTION

The following description with reference to the accompanying drawings is provided to assist in a comprehensive understanding of embodiments of the present disclosure. Accordingly, those of ordinary skill in the art will recognize that various changes and modifications of the embodiments described herein can be made without departing from the scope and spirit of the present disclosure. Descriptions of well-known functions and constructions may be omitted for the sake of clarity and conciseness.

Similarly, in the accompanying drawings, some elements may be exaggerated, omitted, or schematically illustrated. The size of each element does not completely reflect the actual size. Identical or corresponding elements are provided with identical reference numerals.

The components included in the disclosure are expressed in a singular or plural form. However, the singular or plural expression is appropriately selected according to a particular situation for the sake of convenience, and the disclosure is not limited to a single component or a plurality of components. The components expressed in the plural form may be configured as a single component, and the components expressed in the singular form may be configured as a plurality of components.

The advantages and features of the disclosure and ways to achieve them will be apparent by making reference to embodiments as described below in detail in conjunction with the accompanying drawings. However, the disclosure is not limited to the embodiments set forth below, but may be implemented in various forms. Throughout the specification, the same or like reference numerals designate the same or like elements.

Herein, the term unit refers to a software element or a hardware element, such as a field programmable gate array (FPGA) or an application specific integrated circuit (ASIC), which performs a predetermined function. However, the unit does not always have a meaning limited to software or hardware and may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” in the embodiments may include one or more processors.

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the disclosure, terms referring to network entities or network functions or entities of edge computing systems, terms referring to messages, terms referring to identification information, and the like are illustratively used for the sake of descriptive convenience. Therefore, the disclosure is not limited by the terms as used below, and other terms referring to subjects having equivalent technical meanings may be used.

In the following description, the disclosure will be described using terms and names defined in the LTE and NR standards, which are the latest standards specified by the 3rd generation partnership project (3GPP) group among the existing communication standards, for the sake of descriptive convenience. However, the disclosure is not limited by these terms and names, and may be applied in the same way to systems that conform to other standards. In particular, the disclosure may be applied to the 3GPP NR (5th generation mobile communication standards). In addition, embodiments of the disclosure may also be applied to other communication systems having similar technical backgrounds or channel types. Furthermore, based on determinations by those skilled in the art, the embodiments of the disclosure may also be applied to other communication systems through some modifications without significantly departing from the scope of the disclosure.

A 5G mobile communication network may include a 5G user equipment (UE), a 5G radio access network (RAN), and a 5G core network. The 5G core network may include network function (NF) s including an access and mobility management function (AMF) that provides a mobility management function for the UE, a session management function (SMF) that provides a session management function, a user plane function (UPF) that performs a data transfer role, a policy control function (PCF) that provides a policy control function, a unified data management (UDM) that provides a function of managing data, such as subscriber data and policy control data, or a unified data repository (UDR) that stores data of various network functions including the UDM.

In a 5G system, network slicing technology is a technology by which several virtualized and independent logical networks may be provided in one physical network. A network operator may configure a virtual end-to-end network called a network slice to provide a service so as to satisfy a specialized requirement of a service/application. A third party (e.g., an application service provider) providing a particular service may make a contract on one or several network slices with a network operator, and allow traffic for a particular application to be transmitted and/or received between a terminal and a server through the contracted slice(s). A network slice may be distinguished by an identifier named a single-network slice selection assistance information (S-NSSAI), and a network may support an S-NSSAI in a unit of a tracking area (TA). A TA denotes a set of cells, and all the cells may be associated with the TA. An identifier (e.g., a tracking area identity (TAI)) of a TA may be configured by a mobile country code (MCC), a mobile network code (MNC), and a tracking area code (TAC). For example, TA 1 supporting S-NSSAI 1 may indicate that all cells belonging to TA 1 support S-NSSAI 1, and may indicate that all the cells belonging to TA 1 are enabled to perform resource allocation for S-NSSAI 1. A 5G system may force an S-NSSAI to be not available outside an area supporting the S-NSSAI.

The disclosure proposes a method of network slice replacement for a PDU session, based on a terminal. According to an embodiment of the disclosure, when a terminal determines that replacement of an S-NSSAI of a PDU session is needed, S-NSSAI replacement for the PDU session may be possible. In an embodiment, when an S-NSSAI not matched to a matched UE route selection policy (URSP) rule is configured for a PDU session by an evolved packet core (EPC), a terminal may perform an operation for slice replacement for the PDU session. In an embodiment, when a terminal determines that an S-NSSAI for a pre-established PDU session is unavailable (e.g., a slice-available area is stored in the terminal as configuration information, and a currently accessed cell exists out of the slice-available area), the terminal may perform an operation for slice replacement for the pre-established PDU session.

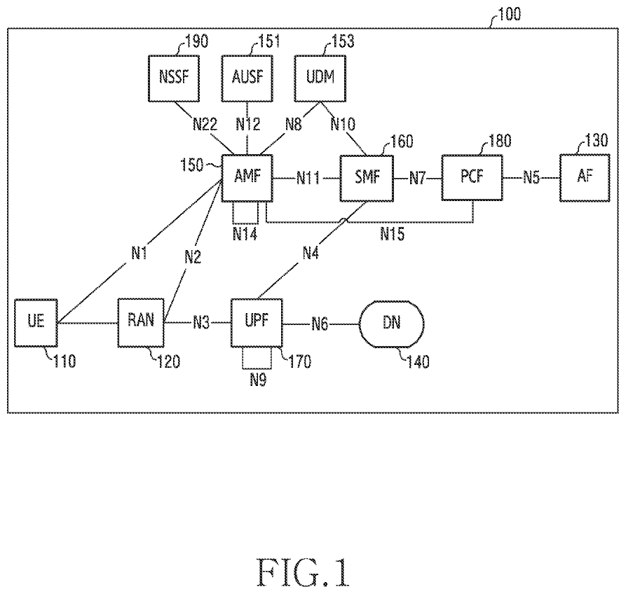

FIG. 1 illustrates a communication network including core network entities in a wireless communication system according to an embodiment.

Referring to FIG. 1, the 5G core network may include network functions including an access and mobility management function (AMF) 150 that provides a mobility management function for the UE 110, a session management function (SMF) 160 that provides a session management function, a user plane function (UPF) 170 that performs a data transfer role, a policy control function (PCF) 180 that provides a policy control function, a unified data management (UDM) 153 that provides a function of managing data, such as subscriber data and policy control data, or a unified data repository (UDR) that stores data of various network functions.

The terminal (user equipment, UE) 110 may perform communication through a wireless channel, that is, an access network, which is established between the terminal and a base station (e.g., eNB or gNB). The terminal 110 is configured to provide a user interface (UI). For example, the UE 110 may be a terminal equipped in a vehicle for driving and performs MTC operated without the user's involvement, or an autonomous vehicle. The UE may be referred to as an electronic device, a terminal, a vehicle terminal, a mobile station, a subscriber station, a remote terminal, a wireless terminal, a user device, or other terms having a technical meaning equivalent thereto. A customer-premises equipment (CPE) or a dongle type terminal may be used as well as a UE. The CPE may be connected to a next generation (NG)-RAN node similar to a UE, and provide a network to other communication equipment, such as a laptop.

The AMF 150 may provide a function for access and mobility management in a unit of the terminal 110 connected to the AMF 150. Specifically, the AMF 150 may perform at least one function among signaling between core network nodes for mobility between 3GPP access networks, N2 interface) with a 5G RAN 120, non-access stratum (NAS) signaling with the terminal 110, identification of the SMF 160, and provision of transport of a session management (SM) message between the terminal 110 and the SMF 160. Some or all functions of the AMF 150 may be supported in a single instance of one AMF 150.

Referring to FIG. 1, the SMF 160 may provide a session management function, and when the terminal 110 has multiple sessions, the sessions may be managed by different SMFs 160. Specifically, the SMF 160 may perform at least one function among session management (e.g., session establishment, modification, and release with tunnel maintenance between the UPF 170 and an access network node), selection and control of a user plane (UP) function, configuration of traffic steering for routing traffic from the UPE 170 to a proper destination, termination of an SM part of a NAS message, downlink data notification (DDN), and an initiator of AN-specific SM information (e.g., transfer to the access network through N2 interface via the AMF 150). Some or all functions of the SMF 160 may be supported in a single instance of one SMF 160.

In a 3GPP system, a conceptual link connecting NFs in a 5G system may be called a reference point. The reference point may be also called an interface. The following description of the reference points or interfaces included in a 5G system architecture represented herein:
N1: A reference point between the UE 110 and the AMF 150
N2: A reference point between the (R)AN 120 and the AMF 150
N3: A reference point between the (R)AN 120 and the UPF 170
N4: A reference point between the SMF 160 and the UPF 170
N5: A reference point between the PCF 180 and an AF 130
N6: A reference point between the UPF 170 and a DN 140
N7: A reference point between the SMF 160 and the PCF 180
N8: A reference point between the UDM 153 and the AMF 150
N9: A reference point between two core UPFs 170
N10: A reference point between the UDM 153 and the SMF 160
N11: A reference point between the AMF 150 and the SMF 160
N12: A reference point between the AMF 150 and an authentication server function (AUSF) 151
N13: A reference point between the UDM 153 and the authentication server function 151
N14: A reference point between two AMFs 150
N15: In a non-roaming scenario, a reference point between the PCF 180 and the AMF 150, and in a roaming scenario, a reference point between the AMF 150 and the PCF 180 in a visited network

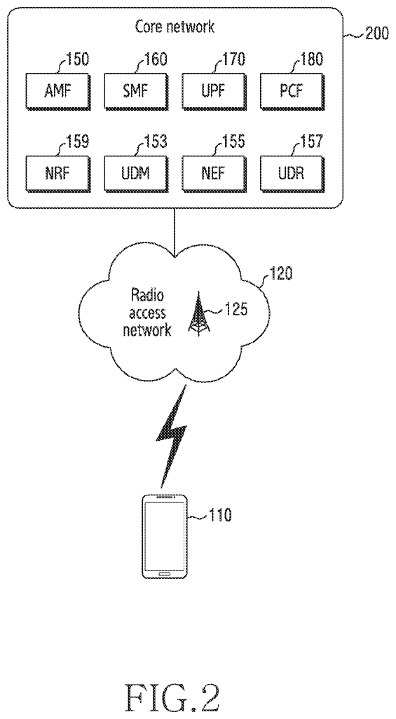

FIG. 2 illustrates a wireless environment including a core network in a wireless communication system according to an embodiment.

Referring to FIG. 2, a wireless communication system may include the RAN 120 and a core network (CN). The RAN 120 is a network directly connected to the terminal 110, and may provide wireless access to the terminal 110. The RAN 120 includes a set of multiple base stations including a base station 125, and the multiple base stations may perform communication through interfaces established therebetween. At least some of the interfaces between the multiple base stations may be wired or wireless. The base station 125 may have a structure in which a central unit (CU) and a distributed unit (DU) are separated from each other. In this case, one CU may control multiple DUs. The base station 125 may be referred to as an access point (AP), a gNB (next generation node B), a 5th generation node (5G node), a wireless point, a transmission/reception point (TRP) or other terms having a technical meaning equivalent thereto. The terminal 110 may access the RAN 120 and communicate with the base station 125 through a wireless channel.

The CN 200 manages the entire system, and may control the RAN 120 and process data and control signals for the terminal 110 which is transmitted or received via the RAN 120. The CN 200 may perform various functions including control of a user plane and a control plane, processing of mobility, management of subscriber information, charging, and linkage with a different type of system (e.g., long-term evolution (LTE) system). To perform the various functions, the CN 200 may include multiple entities that have different NFs and are functionally separated from each other. For example, the CN 200 may include the AMF 150, the SMF 160, the UPF 170, the PCF 180, a network repository function (NRF) 159, the UDM 153, a network exposure function (NEF) 155, and a UDR 157.

The terminal 110 may be connected to the RAN 120 to access the AMF 150 that performs a mobility management function for the CN 200. The AMF 150 is a device that serves both access to the RAN 120 and mobility management for the terminal 110. The SMF 160 is an NF that manages a session. The AMF 150 may be connected to the SMF 160, and may route a session-related message for the terminal 110 to the SMF 160. The SMF 160 may connect to the UPF 170 to allocate a user plane resource to be provided to the terminal 110, and establish a tunnel between the base station 125 and the UPF 170 for data transmission. The PCF 180 may control information related to charging and a policy for a session used by the terminal 110.

The NRF 159 may store information on NFs installed in a mobile communication service provider network, and notify of the stored information. The NRF 159 may be connected to all NFs. Each NF registers itself in the NRF 159 when starting to be operated by the service provider network, thereby notifying the NRF 159 that the NF is being operated in the network. The UDM 153 is an NF that performs a role similar to that of a home subscriber server (HSS) of a fourth generation (4G) network, and may store subscription information of the terminal 110 or context used by the terminal 110 in the network.

The NEF 155 may connect a 3rd party server to an NF in a 5G mobile communication system, may provide data to the UDR 157, and may update data in or obtain data. The UDR 157 may store subscription information of the terminal 120, policy information, data exposed to the outside, or information required for a 3rd party application. The UDR 157 may also provide stored data to another NF.

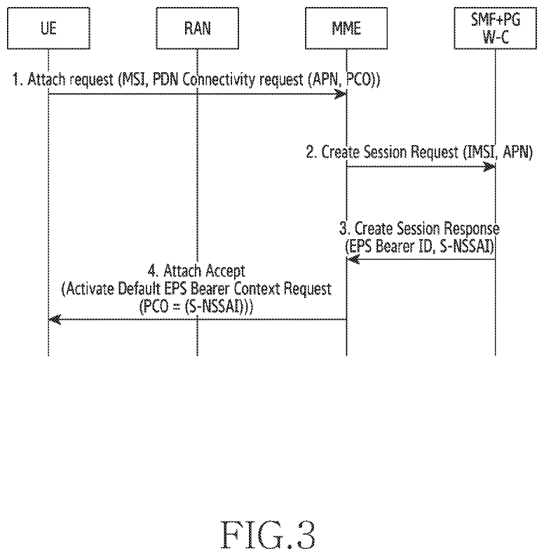

FIG. 3 illustrates a method of storing information related to a PDN connection by a UE in a PDN connection generation procedure according to an embodiment. Specifically, FIG. 3 concerns a method of storing the PDN connection information when an S-NSSAI included in a matched route selection description (RSD) in a URSP rule and an S-NSSAI received from an SMF+PDN gateway control plane function (PGW-C) are different from each other.

Referring to FIG. 3, in step 1, a UE may, when application traffic occurs, transmit a PDN connectivity request message to an MME via a base station (RAN). The PDN connectivity request message may include at least one of an international mobile subscriber identity (IMSI), such as a UE identifier or an access point name (APN), which refers to a network name and has the same meaning as a data network name (DNN). The UE may determine an APN, based on a URSP rule when the UE uses a URSP rule received from a network. Each URSP rule may include a traffic descriptor (TD) including at least one of an application (app) ID or Internet protocol (IP) address information (e.g., a source IP address and port number and a destination IP address and port number) and an RSD including at least one of an S-NSSAI or a DNN. The UE may use, for generated application traffic, a DNN and an S-NSSAI included in a matched RSD of a URSP rule having a TD matched to the application traffic. The UE may determine an APN included in a message to be transmitted to the MME, based on the DNN included in the matched RSD.

In step 2, when the PDN connectivity request message is received from the UE, the MME may transmit a create session request to an SMF+PGW-C via a serving gateway (SGW).

A create session request message may include at least one the IMSI or the APN.

In step 3, the SMF+PGW-C may determine an S-NSSAI for a PDN connection. If there are several S-NSSAIs stored as configuration information for an APN for a PDN connection (e.g., the APN included in the message received in step 2), the SMF+PGW-C may select one from among the multiple S-NSSAIs. The SMF+PGW-C may include a protocol configuration option (PCO) including the selected S-NSSAI in a response message transmitted to the MME.

In step 4, the MME may include the PCO including the S-NSSAI for the PDN connection in an attach accept message transmitted to the UE via the RAN. When the attach accept message is received, the UE may identify a determined S-NSSAI for the requested PDN connection.

If an S-NSSAI exists in the message received in step 4, if a PDN connection request message has been transmitted due to newly generated application traffic in step 1, and if an APN included in the PDN connection request message is determined based on a matched RSD in a URSP rule, the UE may identify whether the S-NSSAI included in the message received in step 4 and the S-NSSAI included in the matched RSD are identical. If the S-NSSAI included in the message received in step 4 and the S-NSSAI included in the matched RSD are different from each other, the UE may determine that the S-NSSAI determined for the requested PDN connection does not follow an S-NSSAI of a matched RSD corresponding to stored policy information (e.g., a URSP rule), and the UE may store a PDU session identity (ID) (or PDN connection ID) and an S-NSSAI included in a matched RSD for a PDN connection for which a determined S-NSSAI is different from an S-NSSAI corresponding to a URSP rule.

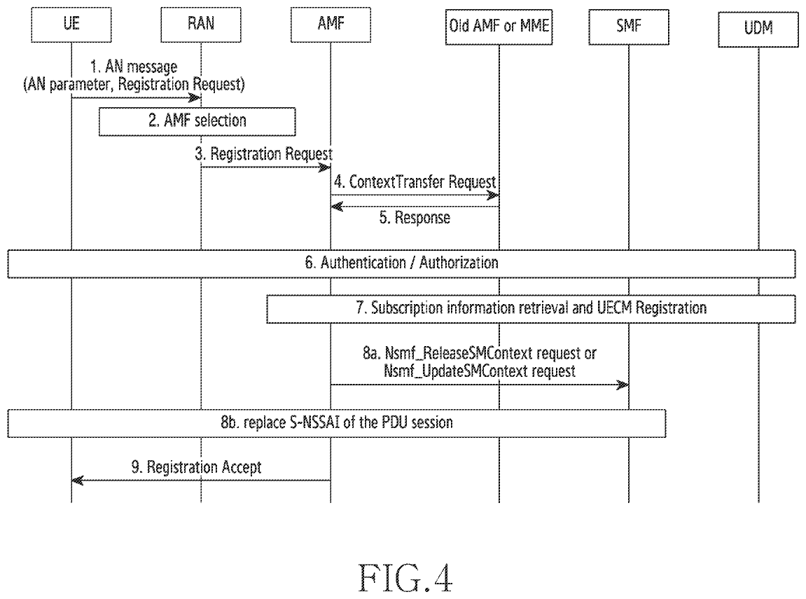

FIG. 4 illustrates a method of transmitting a slice replacement request by a UE in a registration procedure according to an embodiment.

Referring to FIG. 4, in step 1, a UE may transmit an AN message (i.e., (R)AN message) including at least one of an AN parameter or a registration request to a base station (RAN). A registration request message may include at least one of a UE ID including at least one of a subscription concealed identifier (SUCI), a 5G-globally unique temporary identity (5G-GUTI), or a permanent equipment identifier (PEI)), an additional GUTI, a registration type, a requested NSSAI, a UE mobility management (MM) CN capability, or a list of PDU sessions to be activated.

When a registration request is transmitted due to movement from an evolved packet system (EPS) to a 5th generation system (5GS), the UE may include at least one of an indicator indicating movement from the EPS to the 5GS, an old GUTI including a 5G-GUTI mapped from an EPS GUTI, or an additional GUTI including a native 5G-GUTI. The additional GUTI may enable acquisition of the UE's MM context from an old AMF. When a registration request is transmitted due to movement from an EPS to a 5GS, the UE may include a requested NSSAI including an S-NSSAI(s) for an established PDN connection(s) in an N2 message transmitted to the RAN and an N1 message transmitted to an AMF, also referred to as a NAS message. When there is a PDN connection, among the established PDN connections, the S-NSSAI of which is different from an S-NSSAI corresponding to a URSP rule, and an S-NSSAI included in a matched RSD for the PDN connection is stored in the UE, if the S-NSSAI (e.g., the S-NSSAI included in the matched RSD) is not included in an allowed NSSAI of the UE, the UE may include the S-NSSAI included in the matched RSD, in the requested NSSAI.

When a registration request is transmitted due to movement from an EPS to a 5GS and in a case of a PDN connection, among the PDN connections established in the EPS), for which an S-NSSAI included in a matched RSD is stored in the UE, the UE may perform an operation for changing an S-NSSAI of the PDN connection to the S-NSSAI included in the matched RSD.

Specifically, the UE may update an S-NSSAI value associated with internal information stored for a PDU session corresponding to the PDN connection, to the S-NSSAI included in the matched RSD, or may include a PDU session ID of the PDU session and the updated S-NSSAI in a message transmitted to an AMF. The PDU session ID and the updated S-NSSAI may be included in a list of PDU sessions to be activated.

In step 2, the RAN may select an AMF, based on information in the AN message received from the UE.

In step 3, the RAN may transmit an N2 message including at least one of N2 parameters or a registration request to the AMF. An N2 parameter may include at least one of a selected public land mobile network (PLMN) ID, UE location information and an NG-RAN cell global identity (CGI) associated with a cell on which the UE is camping or a UE context request. The N2 message may include a RAN ID.

If there is no previous AMF or MME of the UE (for example, the registration request is an initial registration request), step 4 and step 5 may be omitted.

In step 4, if the AMF is changed, the AMF after the change, i.e., the new AMF, may identify the AMF before change, i.e., the old AMF (or MME) for the UE, based on a 5G-GUTI included in the information received in step 3. The new AMF may transmit an Namf_Communication_UEContextTransfer request message to the old AMF (or MME). The Namf_Communication_UEContextTransfer request message may include at least one of an access type of the UE, an identifier (e.g., 5G-GUTI or SUPI) of the UE, or supported features.

In step 5, when the message of step 4 is received, the old AMF (or MME) may include a UE context and SUPI for the UE identifier included in the received message, in a response message transmitted to the new AMF.

In step 6, an authentication/authorization procedure for the UE may be performed. The AMF may perform the authentication/authorization procedure for the UE via an AUSF.

In step 7, the new AMF may obtain subscriber information for the UE from a UDM and may perform registration for the access type in the UDM. For example, subscription information retrieval and UE Context Management (UECM) registration procedures can be performed.

In step 8a, if the registration request message (e.g., a list Of PDU sessions to be activated in the registration request message) received from the UE includes a PDU session ID and a PDU session ID including an updated S-NSSAI included in the matched RSD, the AMF may determine to change an S-NSSAI value for a PDU session including the updated S-NSSAI, to an S-NSSAI included in information received from the UE. If the AMF determines to change the S-NSSAI, the AMF may include at least one of the following pieces of information in a message transmitted to an SMF, with respect to the PDU session including the updated S-NSSAI.

PDU Session ID or SM Context ID: A PDU session ID (additionally, a PDU session ID received from the MME or old AMF) included in the registration request message received from the UE, or an SM context ID for the PDU session ID may be included.

Alternative S-NSSAI: If there is a PDU session ID received together with an S-NSSAI among PDU session IDs included in the registration request message received from the UE, the S-NSSAI may be included.

S-NSSAI: An existing S-NSSAI for the PDU session ID may be included.

When there is a slice replacement request message (e.g., Nsmf_UpdateSMContext request), a PDU session ID of a particular PDU session may be included. Alternatively, the slice replacement request message (e.g., Nsmf_UpdateSMContext request) may include an SM context ID, an existing S-NSSAI for the PDU session and an alternative S-NSSAI.

The new AMF may determine, according to configuration information, whether to transmit a message that requests release, deactivation, or slice replacement for a PDU session, among the PDU session ID(s) included in the list of PDU sessions to be activated, for which information on a network slice-available area of an S-NSSAI is configured in the new AMF and a current cell ID is not included in the network slice-available area of the S-NSSAI.

In step 8b, if a Nsmf_UpdateSMContext message is received in step 8a and the Nsmf_UpdateSMContext message includes an S-NSSAI and an alternative S-NSSAI, the SMF may perform slice replacement with the alternative S-NSSAI for a PDU session ID included in the Nsmf_UpdateSMContext message. Specifically, the SMF may include an alternative S-NSSAI in messages transmitted to the UE and the RAN. If information received from the AMF includes an alternative S-NSSAI, the SMF may include, in an N1 message transmitted to the UE, at least one of a PDU session ID, an alternative S-NSSAI included in the message received from the AMF, or information instructing to transmit a PDU session establishment request to the same data network. The SMF may transmit the N1 message and an N2 message to the AMF. The AMF may transmit an N2 message including an N1 message to the RAN, based on information received from the SMF, and the RAN may transmit the N1 message included in the received N2 message to the UE. When the N1 message is received, the UE may transmit a PDU session establishment request message to the AMF via the RAN. The PDU session establishment request message may include at least one of the same DNN for a PDU session ID included in the N1 message or an alternative S-NSSAI included in the N1 message.

In step 9, the new AMF may transmit a registration accept message to the UE. The registration accept message may include an allowed NSSAI including at least one of an S-NSSAI included in the requested NSSAI received from the UE or an S-NSSAI for a PDU session ID included in the registration request message received from the UE. The registration accept message may be transferred to the UE via the RAN.

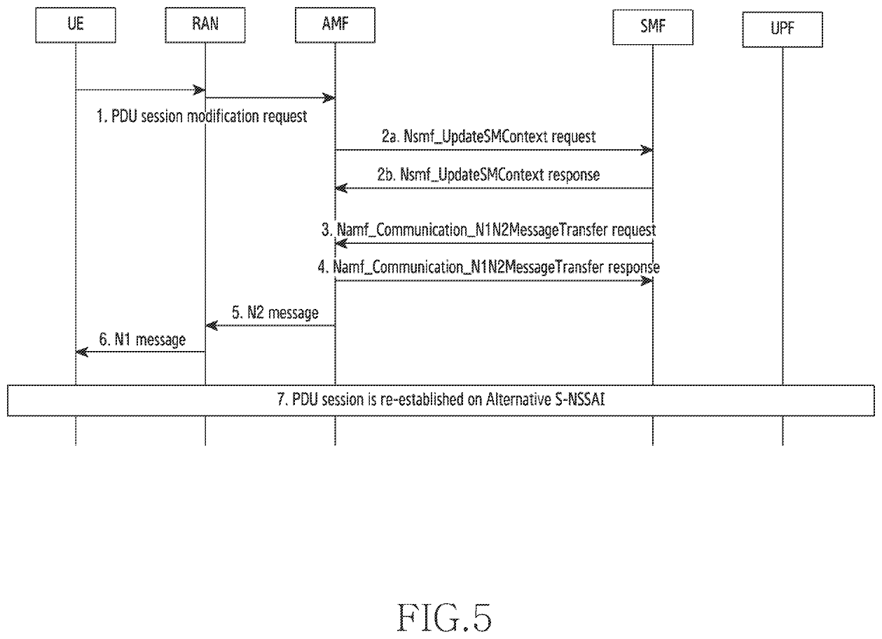

FIG. 5 illustrates a method of performing, by a UE, an S-NSSAI replacement request for a PDU session in a PDU session modification procedure according to an embodiment.

In step 1, a UE may include at least one of the following pieces of information in a message transmitted to an AMF via a RAN, when the UE wants to replace an S-NSSAI for a PDU session among established PDU sessions, with a different S-NSSAI:

### PDU Session ID

Alternative S-NSSAI: An S-NSSAI with which the UE wants to perform replacement for the PDU session ID may be included.

S-NSSAI: An existing S-NSSAI for the PDU session ID may be included.

For example, if there is a PDU session (or associated PDN connection), among the established PDU sessions, for which an S-NSSAI included in a matched RSD is stored, the UE may perform an operation for changing an S-NSSAI of the PDU session or associated PDN connection to the S-NSSAI included in the matched RSD. The PDU session ID and the alternative S-NSSAI of the message transmitted to the AMF may be configured to be a PDU session ID of a PDU session for which an S-NSSAI included in a matched RSD is stored, and the S-NSSAI included in the matched RSD, respectively.

In step 2a, when the message of step 1 transferred via the RAN is received, the AMF may transmit a message to the SMF including at least one of the following pieces of information.

PDU session ID(s) or SM context ID(s): A PDU session ID(s) or SM context ID(s) included in the message received in step 1 may be included.

Alternative S-NSSAI: The AMF may include the alternative S-NSSAI received in step 1. Alternatively, the AMF may use an alternative S-NSSAI received in an NSSF or PCF.

In step 2b, the SMF may transmit a response message for step 2a to the AMF.

In step 3, the SMF may include at least one of the following pieces of information in a message transmitted to the AMF according to the message received from the AMF.

If the message received from the AMF includes an alternative S-NSSAI, the SMF may include at least one of a PDU session ID or an N1 SM container (PDU session release command (alternative S-NSSAI)) in the message transmitted to the AMF. The alternative S-NSSAI may be transmitted after being included in a PDU session modification command or another command message.

In step 4, the SMF may receive a response message for step 3 from the AMF.

In step 5, the AMF may perform one of the following operations when the message of step 3 is received from the SMF.

If the message received from the SMF includes an N1 SM container, the AMF may transmit an N2 message including an N1 message including a PDU session ID and the N1 SM container, to the UE via the RAN.

If the message received from the SMF includes an N2 SM container, the AMF may transmit an N2 message including the N2 SM container to the RAN.

In step 6, if an N2 message received from the AMF includes an N1 message, the RAN may transmit the N2 message including the N1 message to the UE.

In step 7, when a PDU session ID and a PDU session release command (alternative S-NSSAI) or PDU session modification command (alternative S-NSSAI) exist in the message received from the RAN, the UE may transmit a PDU session establishment request message including a DNN for the PDU session ID and the alternative S-NSSAI. In this case, a new PDU session may be generated using the alternative S-NSSAI.

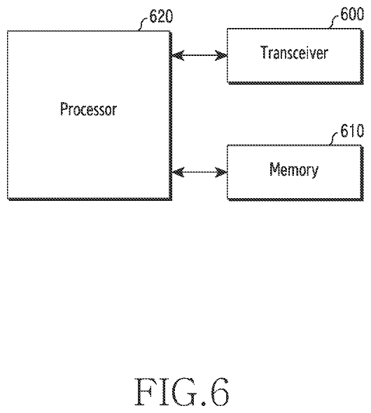

FIG. 6 illustrates a structure of a terminal according to an embodiment.

Referring to FIG. 6, a terminal may include a processor 620, a transceiver 600, and a memory 610. The elements of a terminal are not limited to the above example. For example, the terminal may include more or fewer elements than the above elements. Moreover, the processor 620, the transceiver 600, and the memory 610 may be implemented into a single chip.

The processor 620 may control a series of processes in which the terminal is able to operate according to an embodiment of the disclosure described above. For example, the processor 620 may control the elements of the terminal to perform a method of supporting network slice change according to the above embodiments. The processor 620 may execute a program stored in the memory 610 to control the elements of the terminal such that the above embodiments of the disclosure are performed. In addition, the processor 620 may be an application processor (AP), a communication processor (CP), a circuit, an application-specific circuit, or at least one processor.

The transceiver 600 may transmit or receive a signal to or from a network entity, another terminal, or a base station, which signal may include control information and data. The transceiver 600 may include a radio frequency (RF) transmitter that up-converts and amplifies a frequency of a transmitted signal, an RF receiver that low-noise amplifies a received signal and down-converts the frequency, and the like. However, the elements of the transceiver 600 are not limited to an RF transmitter and an RF receiver. In addition, the transceiver 600 may receive a signal through a wireless channel and output the signal to the processor 620, and may transmit a signal output from the processor 620, through a wireless channel.

The memory 610 may store a program and data required for an operation of the terminal, may store control information or data included in a signal transmitted or received by the terminal, and may be configured by a storage medium such as a read only memory (ROM), a random access memory (RAM), a hard disk, a compact disc (CD)-ROM, and a digital versatile disc (DVD), or a combination of storage mediums. The terminal may include multiple memories 610. The memory 610 may store a program for performing a method of supporting network slice change described above.

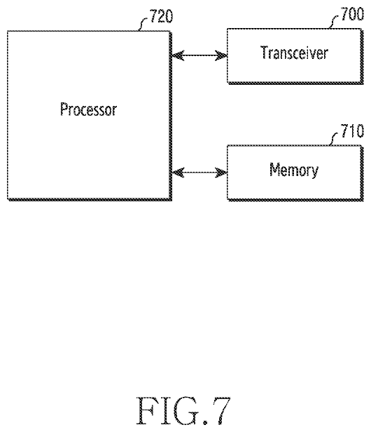

FIG. 7 illustrates a structure of a base station according to an embodiment.

Referring to FIG. 7, a base station may include a processor 720, a transceiver 700, and a memory 710. The elements of a base station are not limited to the above example. For example, the base station may include more or fewer elements than the above elements. Moreover, the processor 720, the transceiver 700, and the memory 710 may be implemented into a single chip.

The processor 720 may control a series of processes in which the base station is able to operate according to an embodiment of the disclosure described above. For example, the processor 720 may control the elements of the base station to perform a method of supporting network slice change according to the above embodiments. The processor 720 may execute a program stored in the memory 710 to control the elements of the base station such that the above embodiments of the disclosure are performed. In addition, the processor 720 may be an AP, a CP, a circuit, an application-specific circuit, or at least one processor.

The transceiver 700 may transmit or receive a signal to or from a network entity, another base station, or a terminal. The signal transmitted or received to or from a network entity, another base station, or a terminal may include control information and data. The transceiver 700 may include an RF transmitter that up-converts and amplifies a frequency of a transmitted signal, an RF receiver that low-noise amplifies a received signal and down-converts the frequency, and the like. However, the elements of the transceiver 700 are not limited to an RF transmitter and an RF receiver. In addition, the transceiver 700 may receive a signal through a wireless channel and output the signal to the processor 720, and may transmit a signal output from the processor 720, through a wireless channel.

The memory 710 may store a program and data required for an operation of the base station. In addition, the memory 710 may store control information or data included in a signal transmitted or received by the base station. The memory 710 may be configured by a storage medium such as a ROM, a RAM, a hard disk, a CD-ROM, and a DVD, or a combination of storage mediums. Multiple memories 710 may be included. The memory 710 may store a program for performing a method of supporting network slice change described above.

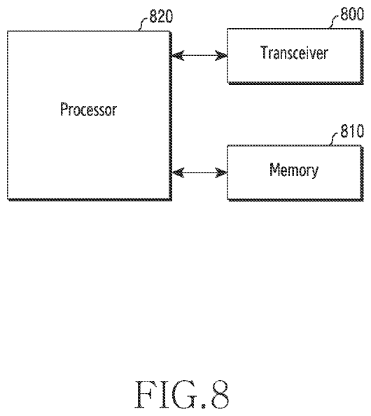

FIG. 8 illustrates a structure of a network entity according to an embodiment.

Referring to FIG. 8, a network entity of the disclosure may include a processor 820, a transceiver 800, and a memory 810. The elements of a network entity are not limited to the above example. For example, the network entity may include more or fewer elements than the above elements. Moreover, the processor 820, the transceiver 800, and the memory 810 may be implemented into a single chip. In addition, the network entity may refer to an NF including a RAN, an AMF, a PCF, a UDM, an AF, an NEF, and a UTM (Unmanned Aircraft System (UAS) Traffic Management).

The processor 820 may control a series of processes in which the NF is able to operate according to an embodiment described above. For example, the processor 820 may control the elements of the network entity to perform a method of supporting network slice change according to the above embodiments. The processor 820 may execute a program stored in the memory 810 to control the elements of the network entity such that the above embodiments of the disclosure are performed. The processor 820 may be an application processor (AP), a communication processor (CP), a circuit, an application-specific circuit, or at least one processor.

The transceiver 800 may transmit or receive a signal to or from another network entity, a base station, or a terminal. The signal transmitted or received to or from another network entity or a terminal may include control information and data. The transceiver 800 may include an RF transmitter that up-converts and amplifies a frequency of a transmitted signal, an RF receiver that low-noise amplifies a received signal and down-converts the frequency, and the like. However, the transceiver 800 merely corresponds to an embodiment, and the elements of the transceiver 800 are not limited to an RF transmitter and an RF receiver. In addition, the transceiver 800 may receive a signal through a wireless channel and output the signal to the processor 820, and may transmit a signal output from the processor 820, through a wireless channel.

The memory 810 may store a program and data required for an operation of the network entity. In addition, the memory 810 may store control information or data included in a signal transmitted or received by the network entity. The memory 810 may be configured by a storage medium such as a ROM, a RAM, a hard disk, a CD-ROM, and a DVD, or a combination of storage mediums. The network entity may include multiple memories 810. In addition, according to an embodiment, the memory 810 may store a program for performing a method of supporting network slice change described above.

The above-described operations of the embodiments may be implemented by providing any unit of a device with a memory device storing corresponding program codes. That is, a controller of the device may perform the above-described operations by reading and executing the program codes stored in the memory device by means of a processor or central processing unit (CPU).

Various units or modules of an entity or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

The methods according to the embodiments described above may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described herein.

Such a program (software module, software) may be stored to a random access memory, a non-volatile memory including a flash memory, a ROM, an electrically erasable programmable ROM (EEPROM), a magnetic disc storage device, a CD-ROM, a DVD or other optical storage device, and a magnetic cassette. Alternatively, it may be stored to a memory combining part or all of those recording media. A plurality of memories may be included.

The program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. A separate storage device on the communication network may access the device which executes an embodiment of the disclosure.

Although the above embodiments have been presented based on the frequency division duplex (FDD) LTE system, other variants based on the technical idea of the above embodiments may also be implemented in other systems such as time division duplex (TDD) LTE, 5G, or NR systems.

Herein, each block of the flowchart illustrations, and combinations of blocks in the flowchart illustrations, can be implemented by computer program instructions provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which includes one or more executable instructions for implementing the specified logical function(s). In some alternative implementations, the functions noted in the blocks may occur out of the order. For example, two blocks shown in succession may in fact be executed substantially concurrently or the blocks may sometimes be executed in the reverse order, depending upon the functionality involved.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) in a wireless communication system, the method comprising:
identifying, while the UE is in an evolved packet system (EPS), a network slice based on a UE route selection policy (URSP) rule;
moving from the EPS to a 5th generation system (5GS); and
transmitting, to a base station, information on the network slice.

2. The method of claim 1,
wherein the information on the network slice is stored in the UE in case that the network slice is different from a network slice allocated from the EPS.

3. The method of claim 1,
wherein the information on the network slice includes at least one of a single-network slice selection assistance information (S-NSSAI), a protocol data unit (PDU) session identity (ID), or a packet data network (PDN) connection ID.

4. The method of claim 1,
wherein the information on the network slice is included in a request message for a PDU session establishment or a PDU session modification.

5. The method of claim 1,
wherein the URSP rule is for selecting the network slice associated with a requested application service.

6. A method performed by a base station in a wireless communication system, the method comprising:
receiving, from a user equipment (UE), information on a network slice in case that the UE moves from an evolved packet system (EPS) to a 5th generation system (5GS),
wherein the network slice is based on a UE route selection policy (URSP) rule.

7. The method of claim 6,
wherein the information on the network slice is stored in the UE in case that the network slice is different from a network slice allocated from the EPS.

8. The method of claim 6,
wherein the information on the network slice includes at least one of a single-network slice selection assistance information (S-NSSAI), a protocol data unit (PDU) session identity (ID), or a packet data network (PDN) connection ID.

9. The method of claim 6,
wherein the information on the network slice is included in a request message for a PDU session establishment or a PDU session modification.

10. The method of claim 6,
wherein the URSP rule is for selecting the network slice associated with a requested application service.

11. A user equipment (UE) in a wireless communication system, the UE comprising:
a transceiver; and
at least one processor coupled with the transceiver and configured to:
identify, while the UE is in an evolved packet system (EPS), a network slice based on a UE route selection policy (URSP) rule;
move from the EPS to a 5th generation system (5GS); and
transmit, to a base station, information on the network slice.

12. The UE of claim 11,
wherein information on the network slice is stored in the UE in case that the network slice is different from a network slice allocated from the EPS.

13. The UE of claim 11,
wherein the information on the network slice includes at least one of a single-network slice selection assistance information (S-NSSAI), a protocol data unit (PDU) session identity (ID), or a packet data network (PDN) connection ID.

14. The UE of claim 11,
wherein the information on the network slice is included in a request message for a PDU session establishment or a PDU session modification.

15. The UE of claim 11,
wherein the URSP rule is for selecting the network slice associated with a requested application service.

16. A base station in a wireless communication system, the base station comprising:
a transceiver; and
at least one processor coupled with the transceiver and configured to:
receive, from a user equipment (UE), information on a network slice in case that the UE moves from an evolved packet system (EPS) to a 5th generation system (5GS),
wherein the network slice is based on a UE route selection policy (URSP) rule.

17. The base station of claim 16,
wherein information on the network slice is stored in the UE in case that the network slice is different from a network slice allocated from the EPS.

18. The base station of claim 16,
wherein the information on the network slice includes at least one of a single-network slice selection assistance information (S-NSSAI), a protocol data unit (PDU) session identity (ID), or a packet data network (PDN) connection ID.

19. The base station of claim 16,
wherein the information on the network slice is included in a request message for a PDU session establishment or a PDU session modification.

20. The base station of claim 16,
wherein the URSP rule is for selecting the network slice associated with a requested application service.
